(19) United States
(12) Patent Application Publication
(10) Pub. No.: US 2023/0376589 A1
(43) Pub. Date: Nov. 23, 2023

(54) MULTI-MODALITY ATTACK FORENSIC ANALYSIS MODEL FOR ENTERPRISE SECURITY SYSTEMS

(71) Applicant: NEC Laboratories America, Inc., Princeton, NJ (US)

(72) Inventors: Zhengzhang Chen, Princeton Junction, NJ (US); Yuncong Chen, Plainsboro, NJ (US); LuAn Tang, Cranbury, NJ (US); Haifeng Chen, West Windsor, NJ (US)

(21) Appl. No.: 18/302,908

(22) Filed: Apr. 19, 2023

Related U.S. Application Data
(60) Provisional application No. 63/450,988, filed on Mar. 9, 2023.
(60) Provisional application No. 63/344,091, filed on May 20, 2022.
(60) Provisional application No. 63/344,085, filed on May 20, 2022.

(51) Int. Cl. G06F 21/55; G06F 21/57

(52) U.S. Cl. CPC G06F 21/552; G06F 21/577; G06F 2221/034; G06F 2221/2101

(57) ABSTRACT

A method for detecting an origin of a computer attack given a detection point based on multi-modality data is presented. The method includes monitoring a plurality of hosts in different enterprise system entities to audit log data and metrics data, generating causal dependency graphs to learn statistical causal relationships between the different enterprise system entities based on the log data and the metrics data, detecting a computer attack by pinpointing attack detection points, backtracking from the attack detection points by employing the causal dependency graphs to locate an origin of the computer attack, and analyzing computer attack data resulting from the backtracking to prevent present and future computer attacks.

### RELATED APPLICATION INFORMATION

This application claims priority to Provisional Application No. 63/450,988 filed on Mar. 9, 2023, Provisional Application No. 63/344,091 filed on May 20, 2022, and Provisional Application No. 63/344,085 filed on May 20, 2022, the contents of all of which are incorporated herein by reference in their entirety.

### BACKGROUND

### Technical Field

The present invention relates to enterprise security systems and, more particularly, to a multi-modality attack forensic analysis model for enterprise security systems.

### Description of the Related Art

Traditionally, enterprises protect themselves by trying to keep attackers outside through perimeter defenses such as firewalls and intrusion prevention systems (IPS). However, given the sophistication of modern attacks, such as drive-by download, phishing emails, contaminated mobile devices, and insider attacks, successful intrusions and compromises are almost unavoidable. For example, recently, there have been many high-profile data breaches at Home Depot, Target, Sony Inc, and eBay. Therefore, in the real world, the fundamental assumption that enterprise security management is simply to prevent attackers from entering into an enterprise no longer holds.

### SUMMARY

A method for detecting an origin of a computer attack given a detection point based on multi-modality data is presented. The method includes monitoring a plurality of hosts in different enterprise system entities to audit log data and metrics data, generating causal dependency graphs to learn statistical causal relationships between the different enterprise system entities based on the log data and the metrics data, detecting a computer attack by pinpointing attack detection points, backtracking from the attack detection points by employing the causal dependency graphs to locate an origin of the computer attack, and analyzing computer attack data resulting from the backtracking to prevent present and future computer attacks.

A non-transitory computer-readable storage medium comprising a computer-readable program for detecting an origin of a computer attack given a detection point based on multi-modality data is presented. The computer-readable program when executed on a computer causes the computer to perform the steps of monitoring a plurality of hosts in different enterprise system entities to audit log data and metrics data, generating causal dependency graphs to learn statistical causal relationships between the different enterprise system entities based on the log data and the metrics data, detecting a computer attack by pinpointing attack detection points, backtracking from the attack detection points by employing the causal dependency graphs to locate an origin of the computer attack, and analyzing computer attack data resulting from the backtracking to prevent present and future computer attacks.

A system for detecting an origin of a computer attack given a detection point based on multi-modality data is presented. The system includes a processor and a memory that stores a computer program, which, when executed by the processor, causes the processor to monitor a plurality of hosts in different enterprise system entities to audit log data and metrics data, generate causal dependency graphs to learn statistical causal relationships between the different enterprise system entities based on the log data and the metrics data, detect a computer attack by pinpointing attack detection points, backtrack from the attack detection points by employing the causal dependency graphs to locate an origin of the computer attack, and analyze computer attack data resulting from the backtracking to prevent present and future computer attacks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary online incident backtrack and system recovery engine, in accordance with embodiments of the present invention;

FIG. 2 is a block/flow diagram of an exemplary architecture for automatic security intelligence systems, in accordance with embodiments of the present invention;

FIG. 3 is a block/flow diagram of an exemplary method for computer system security management using differential dependency tracking for a plurality of hosts in an enterprise, in accordance with embodiments of the present invention;

FIG. 4 is a block/flow diagram of an exemplary integrated causal dependency graph generation pipeline, in accordance with embodiments of the present invention;

FIG. 5 is a block/flow diagram of an exemplary overview of a multi-modality causality dependency graph generation system, in accordance with embodiments of the present invention;

FIG. 6 is a block/flow diagram of an exemplary processing system for detecting an origin of a computer attack given a detection point based on multi-modality data, in accordance with embodiments of the present invention; and

FIG. 7 is a block/flow diagram of an exemplary method for detecting an origin of a computer attack given a detection point based on multi-modality data, in accordance with embodiments of the present invention.

### DETAILED DESCRIPTION OF PREFERRED EMBODIMENTS

The exemplary embodiments backward trace back the origin of the attack given a detection point based on the multi-modality data including metrics data and log data. For example, if a malware instance is wanted inside a computer, a user needs to trace back how such a malware got into the system in the first place. This helps system administrators identify and patch the root causes of the intrusion and strengthen the enterprise's security.

A key challenge in attack forensics is the increasing complexity of modern enterprise systems. Conventional systems and methods backtrack attacks by generating causal dependency graphs by connecting the OS-level objects (e.g., files, processes, and sockets) by system events in temporal order. However, the complexity of the enterprise system introduces a plethora of dependencies among different components and applications across the enterprise. Thus, it is challenging to effectively and accurately detect and/or prune away resources unrelated to attacks to generate an accurate and concise backtracking graph.

In the exemplary embodiments, instead of generating “physical” causal dependency graphs by connecting the OS-level objects (files, processes, and sockets) by system events in temporal order, the exemplary methods and systems leverage representation learning and graph neural networks to learn the “statistical” causal relationships between different system entities based on the multi-modality system monitoring data (including the log data and metrics data).

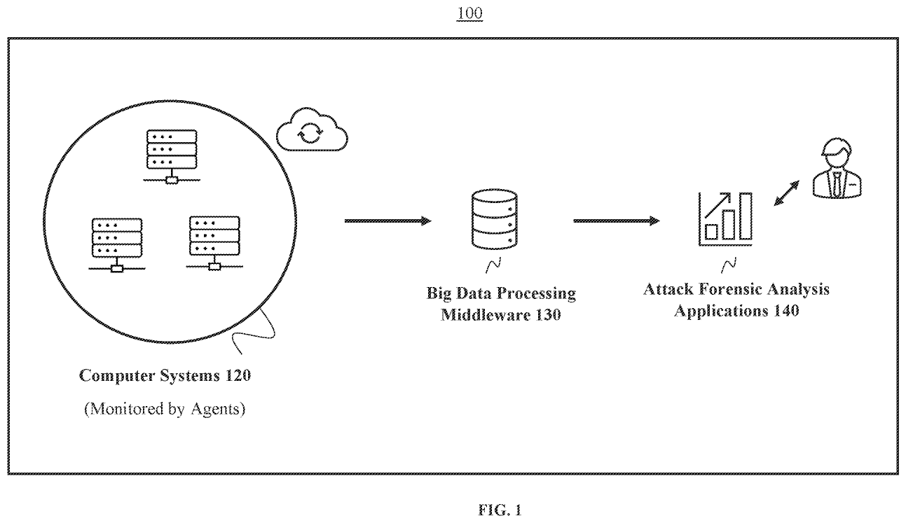

FIG. 1 is a block/flow diagram of an exemplary online incident backtrack and system recovery engine 100, in accordance with embodiments of the present invention.

Computer systems 120 connected to a cloud and monitored by agents provide data to big data processing middleware 130, which outputs results to attack forensic analysis applications 140.

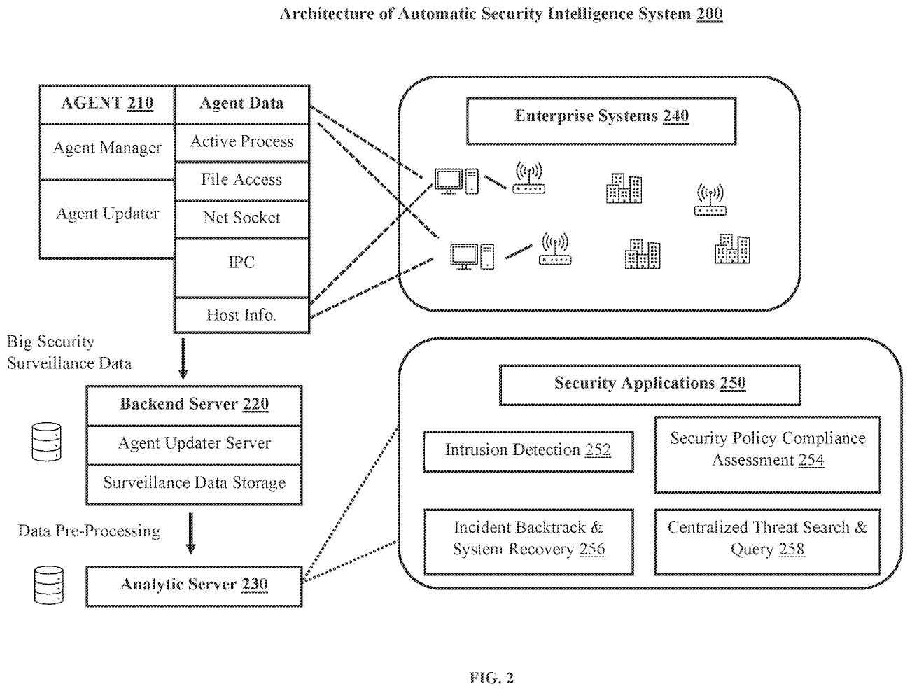

FIG. 2 is a block/flow diagram of an exemplary architecture for automatic security intelligence systems, in accordance with embodiments of the present invention.

FIG. 2 shows the overall architecture of the Automatic Security Intelligence (ASI) system 200. There are three major components, that is, the agent 210, which is installed in each machine of the enterprise network 240 to collect operational data, the backend servers 220, which receive the data from the agents 210, pre-process the data, and send the data to the analytic server 230. The analytic server 230 runs the security application programs to analyze the data. The incident backtrack and system recovery engine 256 is a major application to track and analyze security incidents, identify the source of the attack, and determine the extent of the damage. It is incorporated within the security applications 250. The security applications 250 also include an intrusion detector 252, a security policy compliance assessor 254, and a centralized threat search and query component 258. It is also used to recover lost or corrupted data and restore systems to their pre-attack state. The incident backtrack and system recovery engine 256 can be used by security analysts, incident response teams, and system administrators to respond to security incidents and minimize the impact on the affected systems and networks quickly and effectively. The technique of the exemplary invention is integrated in the incident backtrack and system recovery engine 256.

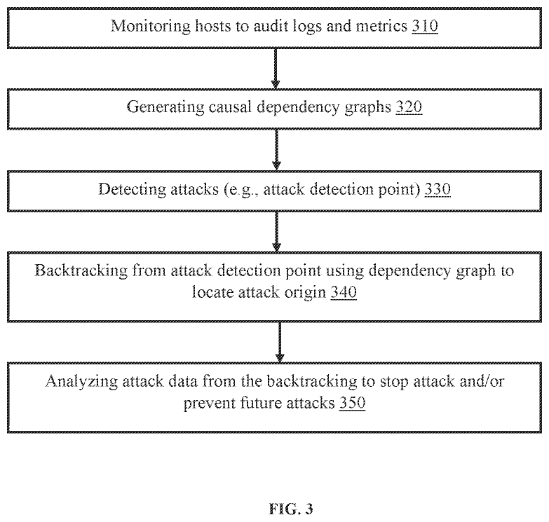

FIG. 3 is a block/flow diagram of an exemplary method for computer system security management using differential dependency tracking for a plurality of hosts in an enterprise, in accordance with embodiments of the present invention.

At block 310, hosts are monitored to audit logs and metrics.

At block 320, causal dependency graphs are generated.

At block 330, attacked are detected (e.g., at an attack detection point).

At block 340, backtracking occurs from the attack detection point by using a dependency graph to locate attack origin.

At block 350, attack data from the backtracking is analyzed to stop attack and/or prevent future attacks.

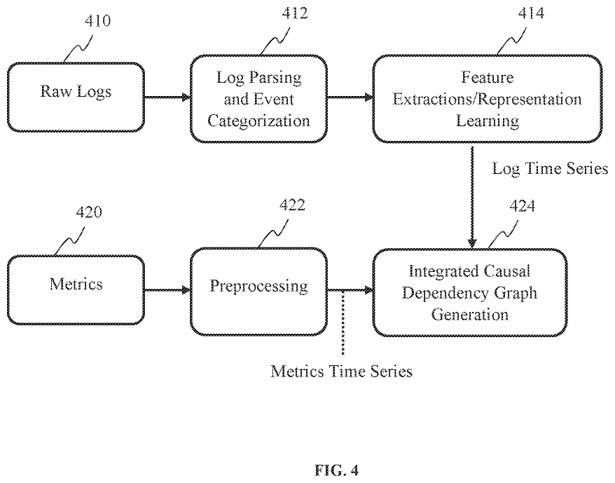

FIG. 4 is a block/flow diagram of an exemplary integrated causal dependency graph generation pipeline, in accordance with embodiments of the present invention.

The raw logs 410 are fed into the log parsing and event categorization component 412. The data is then provided to the feature extraction/representation learning component 414. The metrics 420 are pre-processed by the preprocessing component 422 and fed into the integrated causal dependency graph 424 with the log time series data received from the feature extraction/representation learning component 414.

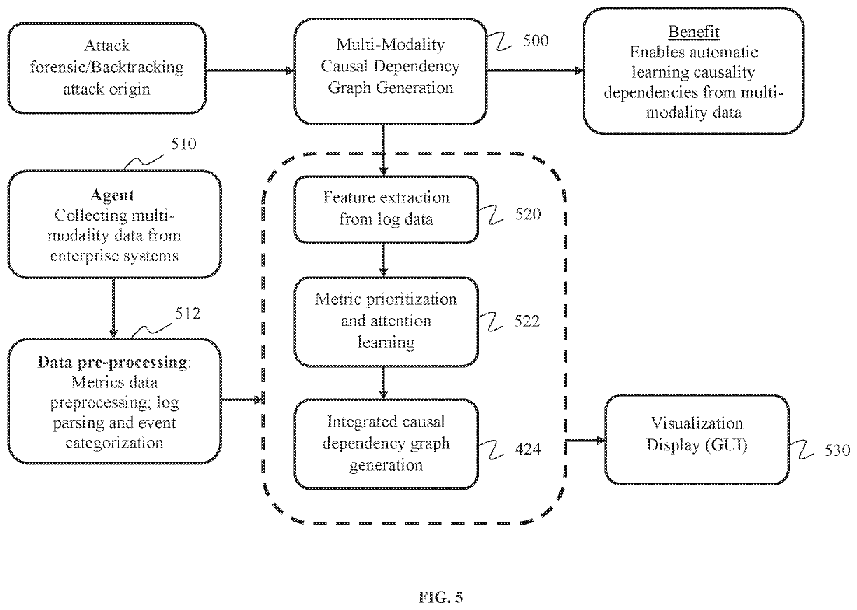

FIG. 5 is a block/flow diagram of an exemplary overview of a multi-modality causality dependency graph generation system, in accordance with embodiments of the present invention.

Regarding the enterprise system monitoring and data collection, the agent 510 collects the enterprise system data by employing the logging agent or tool such as Event Tracing for Windows (ETW) and strace. Two types of monitored data are used in the attack forensic analysis engine, that is, the exemplary methods collect metrics such as response time, CPU usage, memory usage, and network traffic and also collect logs related to different processes such as process creation, file operation, network operations, etc.

Regarding data preprocessing 512, for the log data, the exemplary methods first utilize an open-sourced log parser like “Drain” to learn the structure of the logs and parse them into event/value or key/value pairs. Based on the key/value pairs, the exemplary methods then categorize log messages into a “dictionary” of unique event types according to the involved system entities. For example, if two log messages include the entry of a same pod, they belong to the same category. And for each category, log keys are sliced using time sliding windows.

For metrics data, it is possible that there are different levels of data like high-level (e.g., computer/server level) system metric data and low-level (e.g., process-level) system metric data and for each level, there are different metrics (like CPU usage, memory usage, etc.). The exemplary methods extract the data of the same level and the same metric to construct the multivariate time-series with columns representing system entities (like processes) and rows representing different timestamps.

Regarding feature extraction/representation learning 520 on log data, to capture the interplay between metrics and log data, the exemplary methods employ feature extraction or representation learning techniques to convert log data into the same format (e.g., time-series as metrics data.

The exemplary methods design a novel representation learning model with two sub-components for log data. The first is an auto-encoder model and the second is a language model.

Regarding the auto-encoder model, the auto-encoder includes an encoder network and a decoder network. The encoder network encodes a categorical sequence into a low-dimensional dense real-valued vector, from which the decoder aims to reconstruct the sequence. Due to its effectiveness for sequence modeling, a long short-term memory (LSTM) is used as the base model for both encoder and decoder network.

Specifically, given a normal sequence in the training set, e.g., Sⁱ=(x₁ⁱ, x₂ⁱ, . . . , x_{N}_{ⁱ}ⁱ), the LSTM encoder is used to learn a representation of the whole sequence, step by step, as follows:

fₜ=σ_{g}(W_{f}xₜⁱ+U_{f}hₜ₋₁+b_{f})

iₜ=σ_{g}(Wᵢxₜⁱ+Uᵢhₜ₋₁+bᵢ)

oₜ=σ_{g}(Wₒxₜⁱ+Uₒh^{t-1}+bₒ)

\tilde{c}ₜ=tan h(W_{c}xₜ+U_{c}hₜ₋₁+b_{c})

cₜ=fₜ⊙cₜ₋₁+iₜ+\tilde{c}ₜ

hₜ=oₜ⊙cₜ (1)

Here xᵢ is the input embedding of the t^{th} element in Sⁱ, fₜ,iₜ,oₜ are named as forget gate, input gate, output gate, respectively. In addition, W_{*}, U_{*}, and b_{*} (*∈{f,i,o,c}) are all trainable parameters of the LSTM. The exemplary methods use the final state h_{N}_{ⁱ} obtained by LSTM as the representation of the whole sequence as it summarizes all the information in the previous steps. With the sequence representation h_{N}_{ⁱ}, the LSTM decoder attempts to reconstruct the original sequence recursively as follows:

hₜⁱ=LSTM(hₜ₋₁,\tilde{x}ₜ₋₁ⁱ)

pₜⁱ=Softmax(ReLU(W^{p}hₜⁱ+b^{p}))

êₜⁱ=OneHot(argmax(pₜⁱ))

\hat{x}ₜⁱ=E^{T}·êₜⁱ (2)

Here LSTM is defined in Equation (1), and pₜⁱ∈ [symbol] ^{|ϵ|} is the probability distribution over all possible events. W^{p} and b^{p} are trainable parameters. argmax is the function to obtain the index of largest entry of pₜⁱ, Softmax normalizes the probability distribution, and ReLU is an activation function defined as:

ReLU(x)=max(0,x) (3)

Moreover, êₜⁱ is the predicted event at step t. In addition, the start hidden state and input event are h_{N}_{ⁱ} and special SOS event, respectively.

To optimize the parameters for the encoder and decoder, the negative log likelihood loss is used as the objective function, which is defined as follows:

$${L}_{A E} = {\sum }_{i = 1}^{N} {\sum }_{j = 1}^{{N}^{i}} - log ( {e}_{j}^{i T} {p}_{j}^{i} ) \qquad ( 4 )$$

When the encoder and decoder are trained to reach their optimum, that it, difference between the original and reconstructed sequences is minimum, the representation vector, e.g., h_{N}_{ⁱ} produced by the encoder includes as much information of the sequence as possible.

Regarding the language model, the language model is trained to predict the next event given the previous events in the sequences. Again, an LSTM model is used as the base of the language model. Correctly, given the previous events of at step t, the next event is predicted as:

hₜⁱ=LSTM((x₁ⁱ,x₂ⁱ, . . . ,xₜⁱ)) (5)

pₜ₊₁ⁱ=Softmax(ReLU(W^{l}hₜⁱ+b^{l}))

êₜ₊₁ⁱ=OneHot(argmax(pₜ₊₁ⁱ))

Again, pₜ₊₁ⁱ is the probability distribution over all possible events and êₜ₊₁ⁱ is the one-hot representation of the predicted next event. Similarly, the negative log likelihood loss is used as the objective function. In this way, the trained language model is able to incorporate sequential dependencies in the sequences and measure the likelihood of any given sequence. This likelihood measurement and the vector produced by the encoder are concatenated together to form the final representation of a sequence, that is, v.

The feature extraction component 520 is quite flexible. Different feature extraction or representation learning techniques can be applied. An alternative way is to employ the Principle Component Analysis (PCA) based method. Specifically, the exemplary methods first construct a count matrix M, where each row represents a sequence, each column denotes a log key, and each entry M(i, j) indicates the count of jth log key in the ith sequence. Next, PCA learns a transformed coordinate system with the projection lengths of each sequence. The projection lengths form the time series of log data.

Regarding the metrics prioritization and attention learning component 522 (metric prioritizer and attention learner 522), after the feature extractor 520, the log data have been successfully converted into time series data, which is in the same format of metrics data. Now each extracted feature or representation of log can be considered as another metric in addition to CPU usage, memory usage, etc. Different metrics contribute to the failure event differently. For example, the CPU usage contributes more than the other metrics on the failure cases related to the high CPU load.

To prioritize the metrics for root cause analysis and learn the importance of different metrics, the exemplary methods adopt the extreme value theory-based method named SPOT. It is assumed that the root cause metrics should become anomalous in some time before failure time. The anomaly degree of metrics is evaluated based on SPOT.

The exemplary methods define the anomaly degree of the metric i as ∂ⁱ. Given a time series of metric Mⁱ=M₀ⁱ, M₁ⁱ, . . . , M_{T}ⁱ the index set of the anomaly point of Mⁱ is ε. The threshold in SPOT is denoted as Mₜⁱ is ω_{M}_{ₜ}_{ⁱ}. Then the ∂ⁱ is calculated as follows:

$${\partial }^{i} = {max}_{j ∈ ε} \frac{\vert {M}_{j}^{i} - {ω}_{{M}_{j}^{i}} \vert}{{ω}_{{M}_{j}^{i}}}$$

Since it is often that there are many time series of metric Mⁱ (e.g., 100 different pods with the CPU usage metric), the maximum one ∂ₘₐₓⁱ is chosen as the representative.

The metric with a larger ∂ₘₐₓⁱ has a higher priority. If there are too many metrics, to reduce the computational cost in the root cause analysis, the metrics with very low priorities can be discarded. The normalized ∂ₘₐₓⁱ will be used as the attention/weight for the metric in the integrated causality dependency graph generation component 424.

Regarding the integrated causality dependency graph generator 424, for each metric data including the log as one metric, the exemplary methods apply the hierarchical graph neural network-based method to generate the causality dependency graphs. More specifically, a hierarchical graph neural network based causal discovery method constructs interdependent causal graphs among low-level and high-level system entities. The results can be displayed on the visualization display 530.

The metric of system entities (e.g., high-level or low-level) is a multivariate time series {x₀, . . . x_{T}}. The metric value at the t-th time step is xₜ ∈ [symbol] ^{d}, where d is the number of entities. The data can be modeled using a VAR model, whose formulation is given by:

xₜ^{T}=xₜ₋₁^{T}B₁+ . . . +xₜ₋ₚTBₚ+ϵₜ^{T},t={p, . . . T} (6)

Where p is the time-lagged order, ϵₜ is the vector of error variables that are expected to be non-Gaussian and independent in the temporal dimension, {B₁, . . . , Bₚ} are the weighted matrix of time-lagged data. In the VAR model, the time series at t, xₜ, is assumed to be a linear combination of the past p lags of the series.

Assuming that {B₁, . . . , Bₚ} is constant across time, the equation (6) can be extended into a matrix form:

X=\tilde{X}₁B₁+ . . . +\tilde{X}ₚBₚ+ϵ (7)
where X∈ [symbol] ^{m×d} is a matrix and each of its rows is xₜ^{T}; {\tilde{X}₁, . . . , \tilde{X}ₚ} are the time-lagged data.

To simplify equation (7), let \tilde{X}=[\tilde{X}₁| . . . |\tilde{X}ₚ] with its shape of [symbol] _{mxpd} and B=[B₁| . . . |Bₚ] with its shape of [symbol] ^{mxpd}. Here, m=T+1−p is the effective size because the first p elements in the metric data have no sufficient time-lagged data to for equation (7). After that, the exemplary methods apply the QR decomposition to the weight matrix B to transform equation (7) as follows:

X=\tilde{X}\tilde{B}W+ϵ (8)
where \hat{B}∈ [symbol] ^{mxpd} is the weight matrix of time-lagged data in the temporal dimension and W∈ [symbol] ^{dxd} is the weighted adjacency matrix, which reflects the relations among system entities.

A nonlinear autoregressive model allows xₜ to evolve according to more general nonlinear dynamics. In a forecasting setting, one promising way is to jointly model the nonlinear functions using neural networks. By applying neural networks f to equation (8), the following is obtained:

X=f(\tilde{X}\hat{B}W;Θ)+ϵ (9)
where Θ is the set of parameters of f.

Given the data X and \tilde{X}, the goal is to estimate weighted adjacency matrices W that correspond to directed acyclic graphs (DAGs). The causal edges in W go only forward in time, and thus they do not create cycles. To ensure that the whole network is acyclic, it thus suffices to make sure that W is acyclic. Minimizing the least-squares loss with the acyclicity constraint gives the following optimization problem:

$$min \frac{1}{m} {‖ X - f ( \tilde{X} \hat{B} W ; Θ ‖}^{2} s . t . W is acyclic , \qquad ( 10 )$$

To learn W in an adaptive manner, the exemplary methods adopt the following layer:

W=RELU(tan h(W+W₋^{T}−W₋W₊^{T})), (11)
where W₊∈ [symbol] ^{dxd} and W₋∈ [symbol] ^{dxd} are two parameter matrices. This learning layer aims to enforce the asymmetry of W because the propagation of malfunctioning effects is unidirectional and acyclic from root causes to subsequent entities. In the following sections, W^{G} denotes the causal relations between high-level nodes and W^{A} denotes the causal relations between low-level nodes.

Then, the causal structure learning for the interdependent networks can be divided into-intra-level learning and inter-level learning. Intra-level learning is to learn the causation among the same level of nodes, while inter-level learning is to learn the cross-level causation. To model the influence of low-level nodes on high-level nodes, the exemplary methods aggregate low-level information into high-level nodes in inter-level learning.

For intra-level learning, the exemplary methods adopt the same learning strategy to learn causal relations among both high-level nodes and low-level nodes. Specifically, the exemplary methods first apply L layers of GNN to the time-lagged data {xₜ₋₁, . . . xₜ₋ₚ∈ [symbol] ^{dxp}} to obtain its embedding. In the l-th layer, the embedding z^{(l)} is obtained by aggregating the nodes' embedding and their neighbors' information at the l−1 layer. Then, the embedding at the last layer z^{(L)} is used to predict the metric value at the time step t by an MLP layer. This process can be represented as:

$$\{ \begin{matrix}{z}^{( 0 )} = [ {x}_{t - 1} , … , {x}_{t - p} ] , \\ {z}^{( l )} = G N N ( C a t ( {z}^{( l - 1 )} , W \cdot {z}^{( l - 1 )} ) \cdot {B}^{( l )} ) , \\ {\breve{x}}_{t} = M L P ( {z}^{( L )} ; Θ ) ,\end{matrix} \qquad ( 12 )$$

where CAT is the concatenation operation, B^{(l)} is the weight matrix of the l-th layer, GNN is activated by the RELU function to capture non-linear correlations in the time-lagged data. The goal is to minimize the difference between the actual value xₜ and the predicted value \hat{x}ₜ. Thus, the optimization objective is defined as follows:

$$ℒ = \frac{1}{m} {\sum }_{t} {( {x}_{t} - {\breve{x}}_{t} )}^{2} \qquad ( 13 )$$

The exemplary embodiments conduct intra-level learning for the low-level and high-level system entities for constructing [symbol] and W^{G}, respectively. The optimization objectives for the low-level and high-level causal relations, in the same format as equation (13), are denoted by [symbol] and [symbol] , respectively.

For inter-level learning, the exemplary methods aggregate the information of low-level nodes to the high-level nodes for constructing the cross-level causation. So, the initial embedding of high-level nodes z⁽⁰⁾ is the concatenation of their time-lagged data {xₜ₋₁, . . . xₜ₋ₚ} and aggregated low-level embeddings, which can be formulated as follows:

z⁽⁰⁾=Cat([xₜ₋₁, . . . xₜ₋ₚ],W·z^{(L)}) (14)

Where W is a weight matrix that controls the contributions of low-level embeddings to high-level embeddings. There are two inter-level learning parts. The first one is used to learn the cross-level causal relations between low-level and high-level nodes, denoted by W^{AG}. The second one is used to construct the causal linkages between high-level nodes and the system KPI, denoted by W^{GS}. During this process, the exemplary methods predict the value of the system KPI at the time step t and aim to make the predicted values close to the actual ones. Thus, the exemplary methods formulate the optimization objective [symbol] , whose format is the same as equation (13).

In addition, the learned interdependent causal graphs must meet the acyclicity requirement. Since the cross-level causal relations [symbol] and W^{GS} are unidirectional, only [symbol] and W^{G} need to be acyclic. To achieve this goal, the exemplary methods use the trace exponential function: h(W)=tr(e^{WºW})−d=0 that satisfies h(W)=0 if any only if W is acyclic. Here, º is the Hadamard product of two matrices. Meanwhile, to enforce the sparsity of W^{A}, W^{G}, [symbol] , and W^{GS} for producing robust causation, the exemplary methods use the L1-norm to regularize them. So, the final optimization objective is given as:

L_{final}=( [symbol] +L_{G}+L_{S})

+λ₁(∥W^{A}∥₁+∥W^{G}∥₁+∥ [symbol] ∥₁+∥W^{GS}∥₁)

+λ₂(h(W^{A})+h(W^{G})) (15)

where ∥·∥₁ is the element-wise L1-norm, and λ₁ and λ₂ are two parameters that control the contribution of regularization items. The goal is to minimize L_{final} through the L-BFGS-B solver. When the model converges, the exemplary methods construct interdependent causal networks through W^{A}, W^{G}, [symbol] , and W^{GS}.

In conclusion, the exemplary approach is fully automated and can be adopted to many different environments automatically. The results produced by the exemplary approach are more concise and easier for humans to comprehend. Compared to existing works, which are solely based on system events data to generate the causal dependency graph, the exemplary approach leverages multi-modality data including the log data and metrics data, which can filter out many noisy relationships, and make the dependency graph more reliable. Moreover, comparing existing works that generate causal dependency graphs by connecting the OS-level objects via system events in temporal order, the exemplary approach leverages representation learning and graph neural networks to learn the causal relationships between different system entities based on the multi-modality system monitoring data, which results in a more accurate and concise backtracking graph.

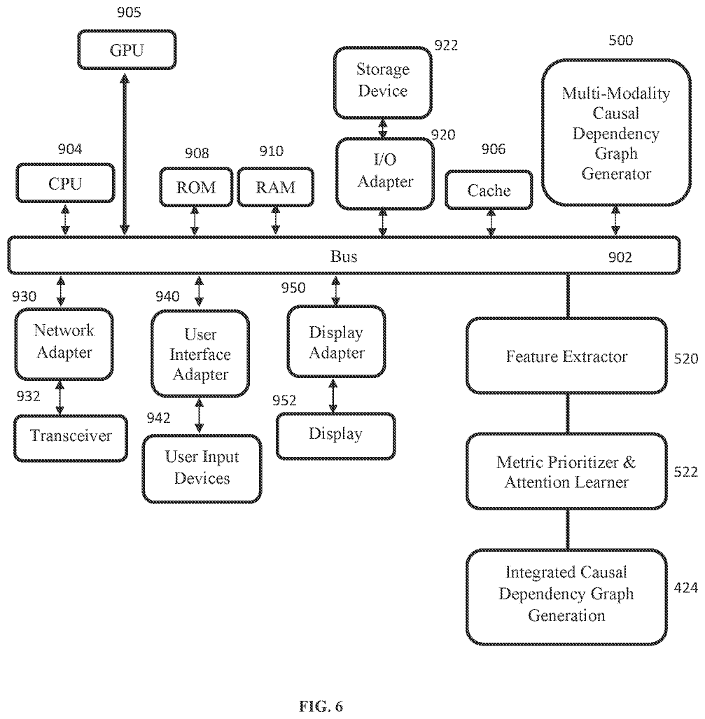

FIG. 6 is an exemplary processing system for detecting an origin of a computer attack given a detection point based on multi-modality data, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the multi-modality causal dependency graph generator 500 employs a feature extractor 520, a metric prioritizer and attention learner 522, and an integrated causal dependency graph generation 424.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

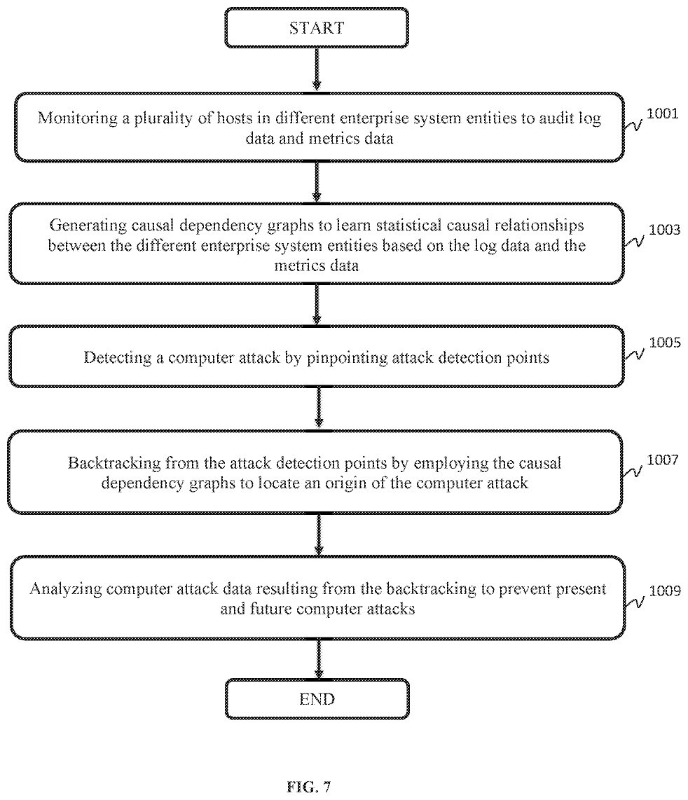

FIG. 7 is a block/flow diagram of an exemplary method for detecting an origin of a computer attack given a detection point based on multi-modality data, in accordance with embodiments of the present invention.

At block 1001, monitor a plurality of hosts in different enterprise system entities to audit log data and metrics data.

At block 1003, generate causal dependency graphs to learn statistical causal relationships between the different enterprise system entities based on the log data and the metrics data.

At block 1005, detect a computer attack by pinpointing attack detection points.

At block 1007, backtrack from the attack detection points by employing the causal dependency graphs to locate an origin of the computer attack.

At block 1009, analyze computer attack data resulting from the backtracking to prevent present and future computer attacks.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting an origin of a computer attack given a detection point based on multi-modality data, the method comprising:
monitoring a plurality of hosts in different enterprise system entities to audit log data and metrics data;
generating causal dependency graphs to learn statistical causal relationships between the different enterprise system entities based on the log data and the metrics data;
detecting a computer attack by pinpointing attack detection points;
backtracking from the attack detection points by employing the causal dependency graphs to locate an origin of the computer attack; and
analyzing computer attack data resulting from the backtracking to prevent present and future computer attacks.

2. The method of claim 1, wherein the causal dependency graphs are generated by employing a feature extractor and a metric prioritizer.

3. The method of claim 2, wherein the feature extractor uses an auto-encoder model and a language model.

4. The method of claim 1, wherein generating the causal dependency graphs involves employing a learning layer that enforces asymmetry of weighted adjacency matrices corresponding to directed acyclic graphs (DAGs).

5. The method of claim 1, wherein causal structure learning for generating the causal dependency graphs is divided into intra-level learning and inter-level learning, intra-level learning pertaining to learning causation among a same level of nodes and intra-level learning pertaining to learning cross-level causation.

6. The method of claim 5, wherein inter-level learning includes a first part and a second part, the first part used to learn the cross-level causation between low-level and high-level nodes, and the second part used to construct causal linkages between the high-level nodes and key performance indicators (KPI).

7. The method of claim 1, wherein the causal dependency graphs meet an acyclicity requirement.

8. A non-transitory computer-readable storage medium comprising a computer-readable program for detecting an origin of a computer attack given a detection point based on multi-modality data, wherein the computer-readable program when executed on a computer causes the computer to perform the steps of:
monitoring a plurality of hosts in different enterprise system entities to audit log data and metrics data;
generating causal dependency graphs to learn statistical causal relationships between the different enterprise system entities based on the log data and the metrics data;
detecting a computer attack by pinpointing attack detection points;
backtracking from the attack detection points by employing the causal dependency graphs to locate an origin of the computer attack; and
analyzing computer attack data resulting from the backtracking to prevent present and future computer attacks.

9. The non-transitory computer-readable storage medium of claim 8, wherein the causal dependency graphs are generated by employing a feature extractor and a metric prioritizer.

10. The non-transitory computer-readable storage medium of claim 9, wherein the feature extractor uses an auto-encoder model and a language model.

11. The non-transitory computer-readable storage medium of claim 8, wherein generating the causal dependency graphs involves employing a learning layer that enforces asymmetry of weighted adjacency matrices corresponding to directed acyclic graphs (DAGs).

12. The non-transitory computer-readable storage medium of claim 8, wherein causal structure learning for generating the causal dependency graphs is divided into intra-level learning and inter-level learning, intra-level learning pertaining to learning causation among a same level of nodes and intra-level learning pertaining to learning cross-level causation.

13. The non-transitory computer-readable storage medium of claim 12, wherein inter-level learning includes a first part and a second part, the first part used to learn the cross-level causation between low-level and high-level nodes, and the second part used to construct causal linkages between the high-level nodes and key performance indicators (KPI).

14. The non-transitory computer-readable storage medium of claim 8, wherein the causal dependency graphs meet an acyclicity requirement.

15. A system for detecting an origin of a computer attack given a detection point based on multi-modality data, the system comprising:
a processor; and
a memory that stores a computer program, which, when executed by the processor, causes the processor to:
monitor a plurality of hosts in different enterprise system entities to audit log data and metrics data;
generate causal dependency graphs to learn statistical causal relationships between the different enterprise system entities based on the log data and the metrics data;
detect a computer attack by pinpointing attack detection points;
backtrack from the attack detection points by employing the causal dependency graphs to locate an origin of the computer attack; and
analyze computer attack data resulting from the backtracking to prevent present and future computer attacks.

16. The system of claim 15, wherein the causal dependency graphs are generated by employing a feature extractor and a metric prioritizer.

17. The system of claim 16, wherein the feature extractor uses an auto-encoder model and a language model.

18. The system of claim 15, wherein generating the causal dependency graphs involves employing a learning layer that enforces asymmetry of weighted adjacency matrices corresponding to directed acyclic graphs (DAGs).

19. The system of claim 15, wherein causal structure learning for generating the causal dependency graphs is divided into intra-level learning and inter-level learning, intra-level learning pertaining to learning causation among a same level of nodes and intra-level learning pertaining to learning cross-level causation.

20. The system of claim 19, wherein inter-level learning includes a first part and a second part, the first part used to learn the cross-level causation between low-level and high-level nodes, and the second part used to construct causal linkages between the high-level nodes and key performance indicators (KPI).
